(19) United States
(12) Patent Application Publication
(10) Pub. No.: US 2018/0167282 A1
(43) Pub. Date: Jun. 14, 2018

(54) Address Assignment by Port Enumeration in a Software-Defined Network

(71) Applicants: John Reumann, Croton on Hudson, NY (US); Zhang Xu, Croton on Hudson, NY (US); Lazaros Koromilas, Cambridge (GB)

(72) Inventors: John Reumann, Croton on Hudson, NY (US); Zhang Xu, Croton on Hudson, NY (US); Lazaros Koromilas, Cambridge (GB)

(73) Assignee: NoFutzNetworks Inc., Croton on Hudson, NY (US)

(21) Appl. No.: 15/374,293

(22) Filed: Dec. 9, 2016

(51) Int. Cl. H04L 12/24; H04L 29/12; H04L 12/721

(52) U.S. Cl. CPC H04L 41/12; H04L 61/2007; H04L 61/6022; H04L 61/103; H04L 45/26

(57) ABSTRACT

In a software-defined network (SDN) multiple servers and switches (the devices) connect into a (sub-)network under a (logically) centralized controller. As each device boots up it may have physically network connectivity but logically it is not connected to the SDN. In order to establish a logical connection the device must receive a network address assignment. There are legacy protocols for this purpose, e.g., DHCP that could be and have been adapted for use in software-defined networks. This invention specifies a different, enumeration-based method for address assignment in hierarchically-organized SDNs, which exploits the topological properties of the SDN for the purpose of device enumeration. This invention provides both Layer 2 and Layer 3 addresses for each device of the SDN.

### BACKGROUND OF THE INVENTION

### Technical Field

This invention relates to the field of network address assignment in a Software-Defined Network which is controlled by a centralized controller.

### Technical Problem

This invention considers the problem of assigning addresses in a software-defined network (SDN) that comprises multiple independent network devices such as network switches, network interface cards (NICs) and servers.

The network devices are connected together and placed under the control of a (logically) centralized controller.

The network under consideration is mostly static with servers, and switches subject to infrequent changes.

The devices that comprise the SDN need to be assigned communication network addresses in order to communicate with each other within the SDN, to receive traffic and in order to statically enforce tight security. Each device's address should reflect where in the topology said device connects to allow routing and network access controls to be pre-configured.

Each network switch in the network has many ports. Some ports face external networks that are not part of the SDN, called external ports, while all other ports are called internal ports.

In a SDN, no routing, not even L2 is available after power-up unless the controller installs it. In legacy networks L2 and L3 connectivity would normally be established by distributed protocols such as STP [STP], which runs on the network devices themselves, and client server protocols such as BOOTP and DHCP [BOOTP, DHCP], or neighbor discovery [IPV6NEIGH]. Even the simple operation of a network switch resolving the mapping of L3-to-L2 addresses called ARP does not work in an SDN unless programmed. All functionality is software-defined, the flip-side is that it also means that there is no functionality such as communication unless it is explicitly specified by software. In an SDN all of a network's behaviors are specified at runtime by the centralized controller. This invention defines a new alternative for address assignment.

It is possible to adapt legacy network address assignment protocols to operate in an SDN environment or to program the SDN to allow the legacy protocol to operate, but that is cumbersome because those protocols are not designed for use in a software-designed network. They are complex in features as they must operate in nearly all networks under arbitrary conditions, and they need to be tweaked so that their network address assignments become known to the SDN controller. This creates a long, fragile dependency chain. This present invention exploits that fact that SDNs are specific instances of networks for which a software stack is instantiated. It is acceptable that the mechanism for address assignment that is described here is unrelated to and incompatible with all known legacy protocols and that it only works in switched networks that can be statically enumerated.

The invention takes into account the following requirements:

First, a network address assignment mechanism must provide to each network device Layer 2 and Layer 3 addresses for communication.

Second, in order to minimize controller load, addresses should only change if SDN topology changes.

Third, spoofing on the network, i.e., a network device assuming the identity of another, should be prevented by design.

### DISCUSSION OF PRIOR ART

The following paragraphs describe related inventions and published works of prior art that are applicable to the same or variants of this problem, solutions that seem to relate to this invention but for subtle reasons fail to address the problems described above, and other inventions upon which this invention builds. A list of detailed document references is provided following this discussion of Prior Art.

Traditionally computers and network devices receive their network address based on client-server protocols upon the network device broadcasting its unique identity, typically embedded in the device, to an address server. Most common is that the device address assignment bootstraps by using the device's MAC address which is uniquely created by the manufacturer of the network interface card (NIC) and hard-coded into the NIC as a unique ID an address request. The address server looks up its mapping table for the unique-id, if it finds one, it provides it to the requesting device, if not, it creates a new one, updates its own state, and replies with that new mapping to the requesting device.

The previous paragraph is an abstract description of how addresses are assigned in an IPv4 or IPv6 infrastructure with a DHCP server: a client broadcasts a request for address assignment [BOOTP, DHCP] to a central server; this broadcast contains the client's MAC address. The server responds with an address assignment for the device that is based on a lookup table that maps MAC addresses to layer 3 addresses or it assigns an address from a flexible pool. This method is obviously very difficult to secure. In particular, the switches that connect network devices cannot be configured as to which physical network port will receive traffic from a specific MAC, IP or IPv6. This is by design, because the protocols are designed to support client devices that are dynamically plugged in and unplugged from network switches.

IPv6 implements a new neighbor discovery protocol [IPV6NEIGH] solution in which devices self-assign an address suffix and then probe if any other device in the same LAN segment shares the same address. Devices receive an address prefix by asking the nearest gateway for said prefix. This doesn't require an address server program, but it requires broadcasting, multicasting, and other protocol interactions to be implemented in the network and routers. It is also difficult to secure, depends on correct support from all of the network participants. Logic is divided among many entities, which this invention aims to avoid.

In U.S. Pat. No. 8,856,384 the inventors define an alternate method to resolve the DHCP server bottleneck in which the controller simply rewrites legacy DHCP requests to go to alternate DHCP servers based on the requesters network. This method both enables a legacy protocol to be used in an SDN and it provides a method for scaling it, but it is substantially different from the method of this present invention which does not use any legacy protocols.

In U.S. Pat. No. 5,276,813 a method for assigning addresses in a bus system is described which, for the purpose of address assignment is nearly indistinguishable from the [BOOTP] protocol in which a client sends a request and receives a reply message.

U.S. Pat. No. 9,032,054 extends the above U.S. Pat. No. 5,276,813. U.S. Pat. No. 9,032,054, as part of its provisioning process, describes another method for assigning addresses to virtual components in a network, when said components are installed and started by virtual machine managers. The cited patent describes a virtual machine being launched on some machine by a management module, and the virtual network device sending an address request message as described in U.S. Pat. No. 5,276,813 and being granted such an address for a virtual machine. The address assignment problem is solved by creating a database that maps a requestor ID (physical port) to a device ID, which the network management module consults in order to assign an address. U.S. Pat. No. 9,032,054 invention does not address the problem of enumerating an entire software-defined network for the purpose of assigning physical addresses to the physical functions of a network.

### REFERENCES

The following paragraphs list the documents that are cited in this present invention as related art in the technical field of the invention:
U.S. Pat. No. 5,276,813, “Acquiring addresses in an input/output system”, Joseph C. Elliott, Eugene P. Hefferon, Allan S. Meritt, Martin W. Sachs, Mark C. Snedaker assigned to International Business Machines Corp., 1990 Aug. 31,
U.S. Pat. No. 9,032,054, “Method and apparatus for determining a network topology during network provisioning”, Amit Shukla, Arthi Ayyangar, assigned to Juniper Networks Inc., 2012 Aug. 24
U.S. Pat. No. 8,856,384, “System and methods for managing network protocol address assignment with a controller”, Kanzhe Jiang, Shudong Zhou, Robert Edward Adams, Mandeep Singh Dhami, Alexander Stafford David Reimers assigned to Big Switch Corp., 2011 Oct. 14
U.S. Pat. No. 7,660,306B1, “Virtualizing the operation of intelligent network interface circuitry”, Asgeir Thor Eiriksson, Dimitrios Michailidis, Wael Noureddine assigned to Chelsio Communications Inc., 2006 Jan. 12

Other Publications are listed with the reference labels that are used in this present invention.
[DHCP] RFC 2131, Dynamic Host Configuration Protocol, March 1997, R. Droms
[BOOTP] RFC 951, Bootstrap Protocol (BOOTP), September 1985, Bill Croft, John Gilmore
[STP] IEEE 802.1D, IEEE Standard for Local and metropolitan area networks, Media Access Control (MAC) Bridges, 2004, IEEE Computer Society, pp. 57-66
[IPV6NEIGH] RFC 4861, Neighbor Discovery for IP version 6 (IPv6), September 2007, T. Narten, E. Nordmark, W. Simpson, H. Soliman
[TTP] OpenFlow Table Type Patterns, August 2014, ONF-TS017, Open Networking Foundation
[OPENFLOW] OpenFlow Switch Specification, October 2013, ONF TS-012, Open Networking Foundation

### SUMMARY OF THE INVENTION

This invention makes the simplifying assumption of a hierarchical interconnect for the devices in the SDN. Hierarchical is defined as follows. Switches of tier N only connect to switches of tier N−1 and N+1. A switch is of tier 0 if it only connects to external ports and tier 1 ports. tier 0 switches are known in advance and can be specified in a configuration file.

This invention relies on all switches connecting through a separate management network to the controller and having established communication with the controller in a legacy manner on the management network. The connection to the controller is required in order to execute the protocol of this present invention.

All devices in the SDN connect to a logically centralized SDN controller.

This invention treats the address assignment to network devices in a manner that is conceptually related to, but technically vastly different from shared I/O bus enumeration methods such as that of U.S. Pat. No. 5,276,813. What is similar is that the enumerated bus addresses reflect the path to the device, which is an idea that is also present in the hierarchical MAC addresses that are created by this invention. What is different is everything practical, the signalling, the protocols, the exact message exchanges, the namespaces, the methods of enumeration, and the types of addresses created.

In order to scan for new devices, this invention defines a probe packet type that is compatible with the recognized protocols of the SDN network infrastructure but that is intentionally not used in the SDN.

The SDN controller installs rules at each switch that redirect incoming probe messages to the SDN controller.

The SDN controller uses the SDN control protocol to inject probe messages into every port of the network. Those messages will be transmitted on the output port named in the SDN control message.

If the above injected packet flows to another SDN switch, which is prepared with the SDN rule of [2-17], the switch will receive and successfully match the probe message and, in accordance with the installed rule, immediately sends this message back to the controller which injected it per [2-18].

Upon receipt of its own probe message, the controller can infer connection topology as it learns which physical switch received the probe packet from which other switch. The message that returns the probe packet to the controller will contain enough information about the receiving switch itself, in particular its datapath ID, thus is enabling the controller to understand device topology.

If the receiving device is not a switch but a server within the SDN then the device it will also detect the probe packets and optionally derive from the intercepted probe packet its own position in the topology. This invention specifies a formula that the receiving host can use to infer a MAC and IP address for its own network interface within the SDN, purely based on the received probe packet.

The controller continuously injects probe packets to provide a simple method for recovery from failure and detection of changes in the physical network topology of the SDN.

Furthermore, the network is configured to prevent any node other than the controller from inserting probe packets.

The network is configured to drop any packets on SDN ports that do not originate from the MAC and IP that is assigned to that port (or devices behind that port).

Since addresses are computed by a formula, it is possible for every host to automatically populate its ARP tables with each IP and MAC address pair that is valid within the SDN.

### Advantageous Effects of the Invention

The SDN controller learns the connectivity of all switches and hosts that are in the SDN.

The system uses a very minimal set of SDN protocol features, which is a benefit because different hardware vendors support different subsets, and often very restricted subsets, of SDN features.

Each computing device receives an L2 and L3 address that directly corresponds to its position in the topology of the SDN.

Neither the L2 nor the L3 address on the SDN can be spoofed from any port other than the port that is configured for the given L2 and L3 address.

The system is very scalable as the controller enumerates devices rather than having devices apply for addresses on their own which could lead to congestion implosion at the SDN controller.

Liveness is established through continuous pings, thus nodes can infer when they are disconnected from the fabric and enter fail-safe mode.

The addresses adjust automatically on physical reconnection to different ports in the SDN hierarchy.

The system does not require the SDN internal network to be configured in any workable L2 or L3 configuration before bootstrapping.

The addressing system is secure against remote attacks.

The addressing system is secure from attacks from compute devices that constitute the SDN.

This solution does not require ARP, consequently ARP spoofing is eliminated.

The solution is robust against spoofing in general.

### DESCRIPTIONS OF THE DRAWINGS

All drawings are numbered. Sub-elements within each figure are labeled with a three digit number with the first digit representing the number of the figure in which the sub-element first appeared. The second and third digit uniquely identify the sub-element within the figure of its first appearance. The following drawings are provided to aid in the understanding of the detailed description of the invention.

FIG. 1 shows a example system of the kind of system that is subject of this invention, comprising: a controller, a switch and four servers in an SDN.

FIG. 2 shows a the switch communicating its data-path ID to the controller.

FIG. 3 shows two switches and a controller and how a probe message is being forwarded from the controller, to the first switch, then to the second, and then back to the controller.

FIG. 4 shows the packet format of probe packets used in this present invention.

FIG. 5 shows the enumerated MAC address format used in this present invention.

FIG. 6 shows the algorithm used in generating probe message that enumerate the SDN topology.

FIG. 7 shows the algorithm used on every host to enumerate the MAC to IP address mappings on every host that is member of the SDN.

### DETAILED DESCRIPTION OF THE INVENTION

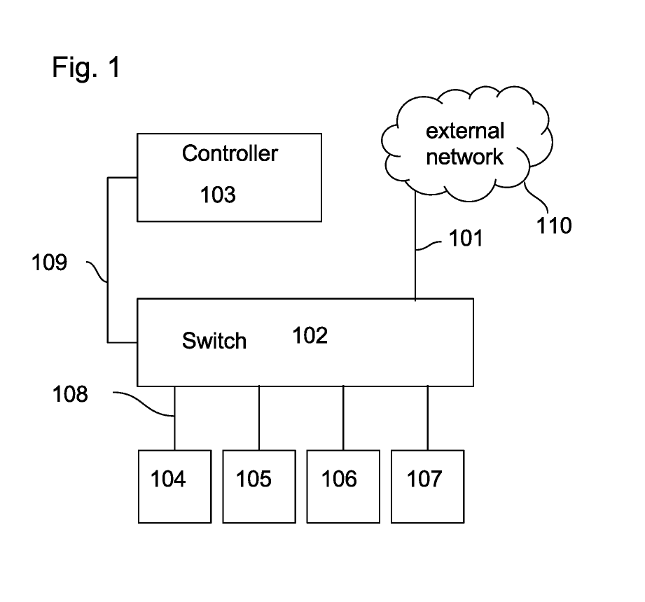

FIG. 1 shows the SDN network comprising a controller, switch, and four hosts. The switch port connects 101 to the external network 110, i.e., ports that do not lead to entities under the control of the SDN controller, while the switch maintains internal connections 108 to other SDN-controlled devices, e.g., servers 104-107. The controller 103 connects to the switch 102 via a separate network connection 109 that is for control.

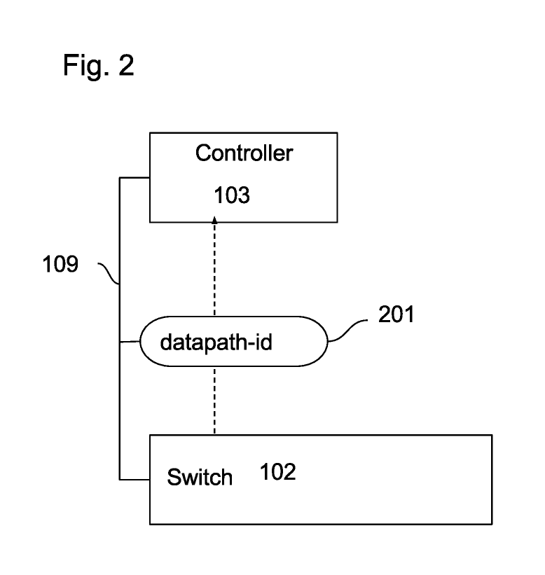

Whenever a switch 102 connects to the controller 103, as shown in FIG. 2, it announces its datapath ID 201 on the connection to the controller. The datapath ID is a per network device ID that is unique in the entire SDN.

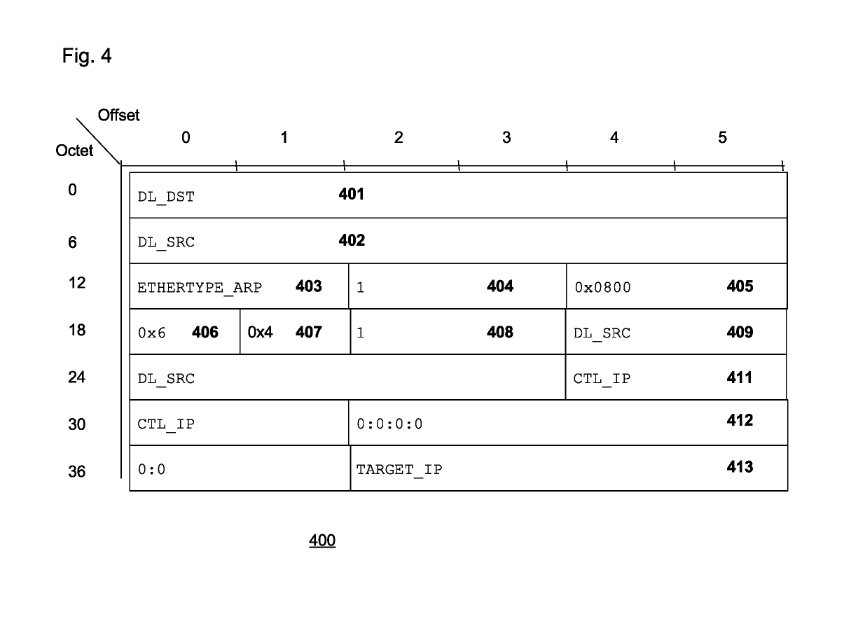

The controller installs a rule on every switch 102 that matches a specific type of packet, called “probe packet,” and forces each matched packet to be sent back to the controller. The probe packet format used in this present invention is derived from the ARP packet, the format is shown in FIG. 4, and explained in 4-20.

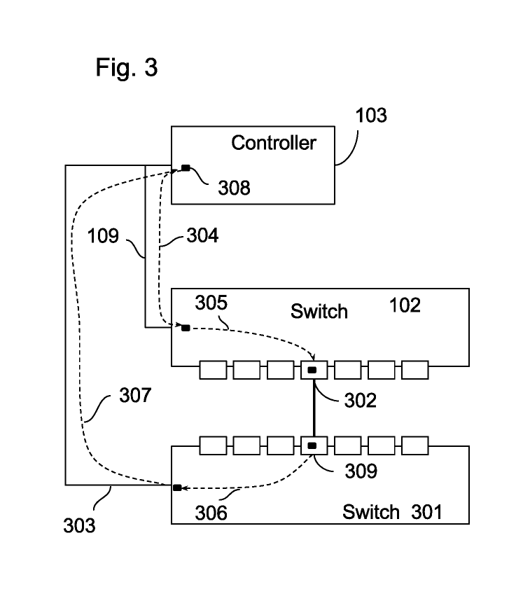

The method of injecting probe packets is depicted in FIG. 3. Here the switches 102 and 301 connect to the controller over their respective control connections 109 and 303. The Controller inserts a probe packet 308 for switch 102 over control connection 109, in which it is encapsulated as an OpenFlow [OPENFLOW] packet output message 304. The packet output message instructs switch 102 to inject 305 the received probe packet 308 into its port 302 from where it travels to the second switch 301 and is received on port 309. Switch 301 matches the received packet as a probe packet per rule that is installed as of [4-03] 306, and sends said packet back in an OpenFlow OFPT_PACKET_IN message 307 to the controller over this switch's 301 previously established control connection 303. This connection is labeled with the datapath ID of the second switch 301 and the packet to the controller 307 contains the identity of the receiving port 309 on switch 301.

It is obvious that the controller can conclude that switch 102 port 302 connects to switch 301 via port 309. Once this operation has completed for all ports and datapaths, the controller 103 can infer the topology of the system via a topological sort.

The sorting operation starts from a known set of top-tier (tier 0) switches, switches that only connect to SDN external networks 110 and tier 1 switches. All switches of tiers greater than 0 are assumed to be internal with regard to the SDN. The controller finds all switches which received a probe packet from a switch that was classified as tier 0, those switches are labeled as tier 1, and switches that have received probe packets from tier 1 are labeled as tier 2, and so on. This procedure is preferably executed recursively, interleaved with the sending of probe packets. For example, first inject probe packets into every tier 0 switch, process the identities of the tier 1 switches, assign numeric IDs to all those tier 1 switches and then inject probe packets into all tier 1 switches and so on, interleaving numbering and probing at every step.

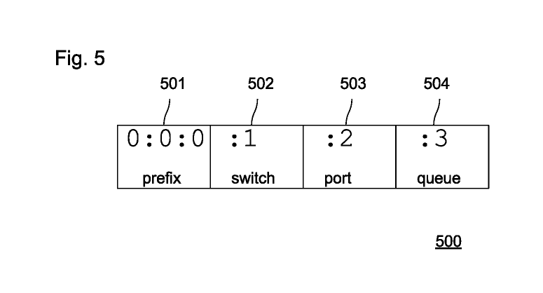

The numbering of switches may be arbitrary, but consecutive and the maximal switch number must not overflow the bits set aside for switch enumeration 502 shown in FIG. 5.

The entire probe packet format itself is shown in FIG. 4. It is a reuse of the ARP frame with a completely changed field interpretation since proper ARP packets are not used in this system. This type of ARP reuse for network probe packets permits matching the newly-invented probe packets within the OpenFlow framework, which anticipates ARP packets but not the packets of this invention. Other frame formats (including custom formats) could be used alternatively without impacting the core function of this invention.

The most important field of the probe packet is DL_DST 401, which is of a special fixed form 500 shown in FIG. 5. In this form, the position of a host device is encoded inside the MAC address: the switch 502 component labels the switch at which the probe packet is injected, with a number assigned to said switch by the controller as described in 4-07. The port 502 is the port number on the switch into which the probe packet is injected. The queue number 504 is the target queue on the receiving network interface card (NIC). This is distinct from the method of U.S. Pat. No. 9,032,054B2 which, without specification, mentions the use of a MAC as a device identifier. First, this present patent does not associate a MACs with virtual resources, MACs are simply associated with physical ports on a switch given the switch ports' position in the enumeration that is initiated by the controller. Second, there is no optionality or handshake or provisioning by the controller, as each device upon receipt of a probe message must prepare itself to accept messages on the routed MAC. Finally, a device in this system does not depend on the controller executing the enumeration. Any other device that sends a packet to a specific MAC in the well-defined format 500, effectively notifies the receiver of its address.

The addressing format 500 of FIG. 5 is flexible in general but fixed in every specific SDN deployment. For the scope of this this invention the assumption is that all control frames for probe messages start with a fixed prefix as in 501, as it helps separate addresses assigned by the SDN from all other addresses. These port numbers 503 could be (and most likely are) physical ports, but occasionally they represent tunnel ports. Switches may have few or many ports but in each SDN deployment there is some maximal number of ports (MAX_PORT) which is not exceeded at any switch in the SDN. MAX_PORT is a constant for the entire SDN. The queue number 504 field is the queue number that is targeted on the receiving NIC. In this case, too, there is some maximal queue number (MAX_QUEUE) across all NICs. MAX_QUEUE is a per SDN constant, too. The field width of the address format 500 must be chosen so that MAX_PORT and MAX_QUEUE can be accommodated.

Each NIC must be configured in such a way that an incoming packet ending with a queue suffix 504 corresponding to the number Q, should be routed to the queue number Q on the receiving NIC. Some NICs allow bitmask matching, in which case such configuration can be performed on every network device 104-107 at boot time to route MAC address suffix to queue Q. Otherwise, these assignments are made when the first probe packet is detected as the probe packet defines the entire prefix and suffix of the address for the receiving NIC. The receiving host, knowing MAX_QUEUE, only needs to enumerate its queues, replacing 504 in the received packet and install fixed MAC-to-queue mappings on the receiving NIC.

The length of the individual fields are shown in the address format 500 as octets in the preferred embodiment but these numbers are deployment specific.

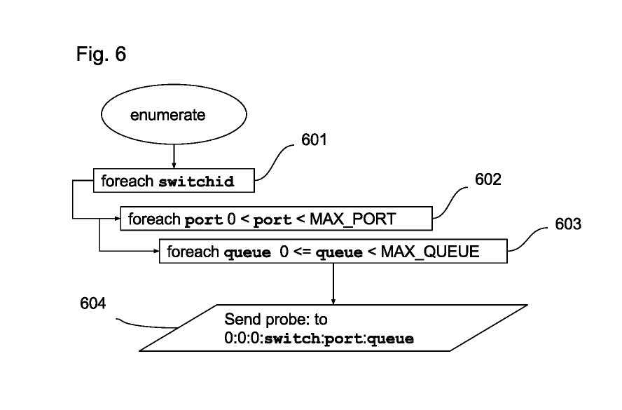

Returning to the controller side of the invention, the nested for-loop (FIG. 6) that the controller executes to enumerate all devices tests for every switch 601, port 602, and queue 603 by inserting a packet of FIG. 4 to a specially crafted destination address of the form 500. The switch sends the probe 400 via the OpenFlow [OPENFLOW] command OFPT_PACKET_OUT with the action to output the packet to port named as port 503.

Each switch is configured with rules of the form:

dl_dst=0:0:0:switch:PORT:queue,action=output:PORT,

so that any packet destined for the given MAC address will always flow to the intended physical port PORT. On each switch there are MAX_PORT*MAX_QUEUE rules of this sort. These rules ensure that even in the absence of routing or MAC learning, a packet sent to a specific MAC of form 500 will always flow to the intended port.

If a switch port PORT connects to another switch 302 SWITCH then an appropriate forwarding rule forwarding must be installed at the upstream switch 102.

dl_dst=0:0:0:SWITCH:0:0/ff:ff:ff:ff:0:0,action=output:PORT,

which means that all ports under SWITCH switch should be forwarded out of PORT.

The above rules ensure forwarding but they do not prevent spoofing, i.e., a switch port injecting packets from a fictitious source MAC or source IP address. To prevent spoofing, ingress packets must be filtered. This can be done by adding an anti-spoofing clause to every forwarding rule that matches a given ingress port PORT on switch SWITCH. Every such rule will be augmented with the additional non-spoofing match restriction,

M1: dl_src=0:0:0:SWITCH:PORT:0/ff:ff:ff:ff:ff:0.

The “added non-spoofing match restriction” approach of [4-16] can be modified on some OpenFlow switches that provide table-type pattern matches TTP [TTP]. Such TTP matches allow installing pure L2 filters on a per-port basis. If such a facility is available, then the source match M1 is installed as an ingress filter in the ingress TCAM in order to permit only traffic matching the non-spoofing match restriction M1.

At all external ports that separate the SDN (under the controller) from other networks 110 that do not obey the controller, the following two filtering rules are installed at highest match priority, in order to drop all specially formatted addresses per format 500 that are being sent to or received from external networks.

phy_port=egress_port,dl_src=0:0:0:0:0:0/ff:ff:ff:0:0:0,action=DROP
phy_port=egress_port,dl_dst=0:0:0:0:0:0/ff:ff:ff:0:0:0,action=DROP

These rules ensure non-interference from remote attacks.

Each computer device with an operating system that is part of the SDN and receives a probe packet may interpret the received packet as follows. Since it received a packet for a specific destination MAC 401, from a source of the form 0:0:0:*:0:0, the receiver can be assured that based on the safety configuration [4-16]-[4-18] of the network, this packet could have only been originated from the controller. Therefore, the DL_DST 401 in the probe packet is the address that per controller should be assigned to the NIC that received the packet. If the receiving NIC is a multi-queue adapter, then it may enumerate the last octet of the received DL_DST MAC address with a number for each queue on the receiving host's NIC and assign the so-enumerated MAC address to the corresponding queue on the NIC using packet steering primitives such as U.S. Pat. No. 7,660,306.

The full probe packet 400 of FIG. 4 is defined as follows. The ethertype of the probe packet is an ARP 403, and its type is Ethernet 404, IPv4 408. The hardware address length 406 for Ethernet is 6 octets and the IP address length for IPv4 is 407 is 4 octets. The message is of type request 408. The DL_SRC 409 is optional but is typically used to encode auxiliary information. The CTL_IP 411 is the management IP address of the controller on the management network 109—this allows any device that is also connected to the control network to exchange optional control messages directly with the controller. This is followed by another 6 octets of unused storage 412 and terminated by the optional TARGET_IP 413 which can be used to provide an IP address to the receiver. If this TARGET_IP 413 is not provided then the receiver will automatically compute its IP as follows: a base IP address (BASE_IP) used in the SDN employment is provided out-of-band to each host in the system as well as the parameters MAX_PORT and MAX_QUEUE. The receiver extracts the DL_DST 401 field from the received probe packet and further extract from said field its components SWITCH 502, PORT 503, and QUEUE 504 to calculate OFFSET:

OFFSET:=(SWITCH*MAX_PORT*MAX_QUEUE)+(PORT*MAX_QUEUE)+QUEUE.

The sum of OFFSET and BASE_IP is a valid IP address for the receiving NIC. This method can be analogously applied to IPv6 addresses.

The receiver of a probe packet, if it is a host, will send back a reply packet. The reply packet swaps the DL_SRC 402 and DL_DST fields 401, and replaces the CTL_IP 411 field with its own (the host's) management IP address, only if the receiver has an interface connected to the management network. If the receiver does not have such a network interface, then the CTL_IP field will be zeroed out in the reply.

The reply to the probe automatically flows to the controller because the controller installs the following rule on every switch:

dl_dst=0:0:0:switch:0:0/ff:ff:ff:0:0:0,action=output:CONTROLLER

In this manner the controller is able to learn which physical ports respond to probe packets, and how the responding device is reached on the management network via a CTL_IP 411.

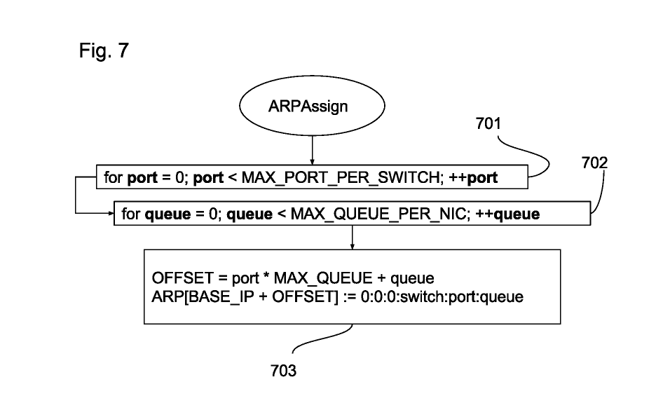

Any host receiving and replying to the probe message, will note its IP address and port number based on the above. It will also extract SWITCH 502 from the received probe packet DL_DST field and execute the algorithm of FIG. 7 in order to populate its own per-host ARP table. For every possible port PORT 701 under switch SWITCH and every possible queue QUEUE 702 it executes 703, which sets up the ARP entry for the enumerated MAC to the given IP address pair based on the received packet. If the number of switches is known in advance then it would be possible to also loop over all switches and pre-populate this ARP table in its entirety.

### EXAMPLE

The SDN of this example is small (see FIG. 1) as it comprises only a single switch and a few servers. The collection of servers and switches implement a firewall in a scale-out manner. None of the devices serve any other purpose than being a component of the scale-out firewall, effectively a software-defined appliance. The SDN only exists within the software-defined appliance.

A firewall can be implemented as a collection of several OpenVSwitch software instances, each running on a server (104-107), with a front-end physical OpenFlow switch 102. The physical OpenFlow 102 switch is configured to split all incoming traffic across all OpenVSwitch instances. This present invention assigns ports and MAC addresses to each of the software OpenVSwitch instances on physical hosts 104-107. Each software OpenVSwitch instance can be configured to receive packets on exactly one CPU and each MAC that is supplied to the host by the probe packets is tied to exactly one NIC queue which is tied to exactly one CPU core by packet steering. This method of traffic to CPU allocation delivers superior processing performance to a default address and resource assignment of resources as is customary in common server deployments.

The absence of probe replies from a well-formed MAC address 500 means that there is no OpenVSwitch and no part of the to-be-firewalled traffic will be forwarded to that MAC address.

All live ports (as evidenced by a reply to a probe message) receive a slice of all incoming traffic from the external network 110 because the controller installs rules at the switch to match incoming packets at the external ports, and rewrites their destination L2 address to a well-formed MAC address 500 representing a live port in the system. The manner of rewriting destination MAC addresses in order to affect load-balancing is outside the scope of this present invention.

What is claimed is:

1. A network address assignment and topology enumeration system for a network comprising:
a centralized controller;
one or more network switches connected to said centralized network controller;
one or more computing device connected to one of said switches by a network interface card;
an interconnect among said switches of hierarchical structure assigning each switch to a tier;
tiers of switches numbered from 0-N in which any switch of tier J, with J being greater than zero and J being less than N connecting only to tiers J−1 and optionally J+1, and tier N if N is greater than 0 connecting only to tier N−1;
a means for detecting and receiving packets at each computing device;
an enumeration of switches in the network;
an enumeration of ports of each switch;
a means for numerically encoding the queues of a network interface card;
a means for encoding the numeric representations of switch, port, and network interface card queue as an enumerated network address;
a means for creating probe packets with a destination of an enumerated network address;
a means for parsing received probe packets with a destination of an enumerated network address;
a means for sending probe packets with destination of enumerated network address;
a means for extracting the network source and destination address from a network packet received by a computing device;
a means for detecting if a network address is a valid enumerated network address;
a means for decoding numeric switch number, port number, and queue number from a network address if said address is an enumerated network address;
a means for the controller to insert routing rules at each of said switches such that packets received at each switch are directed to the switch and physical port that is encoded in said packet's destination address if said address is an enumerated network address;
a means for the controller to insert routing rules at a first switch to send a any packet to the controller if said packet's destination address is an enumerated address that encodes a second switch that is not equal to the first switch;
a means for the controller to inject probe packets at each switch connected to said controller;
a means for assigning to a network interface card the destination address of a probe packet received on said network interface card if said destination address is an enumerated network address;
an optional means of routing a received packet on a network interface card to the specific receive queue on said network interface that is numerically encoded as queue in said packet's destination address provided the destination address is an enumerated network address.

2. The system of claim 1, wherein the controller continuously sends probe packets to enumerated network address for any possible enumerated network address in the entire network.

3. The system of claim 1, wherein a non-controller device that is connected to one of the network's switches sends probe packets addressed to enumerated network addresses that are possible network addresses for other network devices connected to the same network switch as said non-controller device.

4. The system of claim 1, wherein the enumerated network address is a Layer 2 address.

5. The system of claim 1, wherein the enumerated network address is a Layer 3 address.

6. The system of claim 1, wherein address spoofing is prevented, by the controller instructing each switch to install for each physical port corresponding to an enumerated network address,
a first set of rules to only permit the sending of packets addressed to enumerated addresses that match said port's enumerated network address,
and a second set of rules to only permit the receiving of packets sent from source addresses that match said port's enumerated network address,
and an optional third set of rules to deny the sending and receiving of all other network packets.

7. The system of claim 1, wherein all enumerated Layer 2 address share a common prefix.

8. The system of claim 1, wherein external port address spoofing is prevented by the controller instructing each tier 0 switch to insert rules for every port that is facing devices considered outside the network,
to drop a packet received at said port if the received packet's source address represents a valid enumerated network addresses in the network,
and to drop a packet that is to be sent to said port if the destination address of that packet represents a valid enumerated network address in the network.

9. The system of claim 1, wherein means for sending and receiving probe packets is implemented in the form of ARP messages.

10. The method of assigning Layer 2 and Layer 3 addresses in a computer network, comprising:
a network device;
a network device being connected to network interface cards;
a network interface card connected to the computer network;
a network interface card assigned one or more layer 2 addresses;
a network interface card assigned one or more layer 3 addresses;
a layer 2 base address equal to the numerically first assigned layer 2 address in said network;
a layer 3 base address equal to the numerically first assigned layer 3 address in said network;
a method to enumerate consecutive layer 2 addresses;
a method to enumerate consecutive layer 3 addresses;
an upper bound on the total number of consecutive addresses;
a method to determine the validity of a network address with regard to the enumeration;
an assignment constraint such that for every network interface card and layer 2 address assigned thereto it is true that the network interface card is also assigned a layer 3 address that is offset from the network's layer 3 base address by the same integer by which the assigned layer 2 address is offset from the networks layer 2 base address.

11. The method of claim 10, wherein a network device automatically configures its ARP table using the method of
consecutively enumerating each potentially valid layer 2 address in the network starting from the network layer 2 base address but no more in number than the upper bound number placed on the total number of such addresses;
calculating the layer 3 address corresponding to said valid layer 2 address by adding the offset, which is calculated as the absolute difference between said valid layer 2 address and said network's layer 2 base address, to the layer 3 base address;
entering the mapping from the calculated layer 3 address to said valid layer 2 address into the device's ARP table.
